(19) United States
(12) Patent Application Publication
(10) Pub. No.: US 2026/0010379 A1
(43) Pub. Date: Jan. 8, 2026

(54) FIRMWARE ACCESS TECHNOLOGIES

(71) Applicant: Intel Corporation, Santa Clara, CA (US)

(72) Inventors: Gopa DAS, San Jose, CA (US); Jayant MANGALAMPALLI, Corcoran, MN (US); Rahul SHAH, Marlborough, MA (US); Samuel HUI, Hillsboro, OR (US); Ching Yu LO, Portland, OR (US)

(21) Appl. No.: 19/318,253

(22) Filed: Sep. 3, 2025

(51) Int. Cl. G06F 9/4401

(52) U.S. Cl. CPC G06F 9/4416

(57) ABSTRACT

Examples described herein relate to booting a processor by: reading, by a communication circuitry of the processor, boot firmware from a boot firmware storage device; executing, by the communication circuitry, the boot firmware; after the communication circuitry loads and executes the boot firmware, circuitry of the processor utilizing the communication circuitry to load boot firmware by streaming boot firmware from a second boot firmware storage device; and executing, by the circuitry of the processor, the streamed boot firmware.

In a computing system, a hardware device executes firmware as an interface between the device and an operating system (OS) to allow the OS to interact with the device. Devices update their firmware to enhance security, improve performance, and add new features.

### BRIEF DESCRIPTION OF THE DRAWINGS

FIG. 1 depicts an example system.

FIGS. 2A and 2B depict example processes to load boot firmware.

FIG. 3 depicts an example process.

FIG. 4 depicts an example computing system.

### DETAILED DESCRIPTION

During boot of a device, the device accesses a firmware image from a flash memory device using a Serial Peripheral Interface (SPI). A memory device can be partitioned into distinct sections to allow for multiple devices to access firmware in parallel. A boot interface to the memory device can be accessed using physical pins. Increasing a number of physical interconnects to physical pins increases use of motherboard space for interconnects.

Various examples first load boot firmware for a security engine of a processor and communication circuitry that communicates for a processor with a management controller, and after execution of the boot firmware by the security engine and communication circuitry, circuitry of the processor can load boot firmware by streaming boot firmware from the same or different memory device that provided the boot firmware for the security engine and communication circuitry.

Various examples prioritize the loading of firmware components utilized to establish a streaming channel with a firmware storage and defer loading of firmware components for other circuitry from the same or different firmware storage. For example, instead of storing an entirety of firmware in flash storage (e.g., SPI flash), a device retrieves firmware from a host or management controller by communication with a second storage device using a network or interconnect.

Various examples utilize a limited number of interconnects to access firmware through a hub and by accessing firmware for first circuitry of a processor socket from a first memory device and after execution of the firmware by the first circuitry, a second circuitry of the processor socket accesses firmware from a second memory device by communication through the first circuitry.

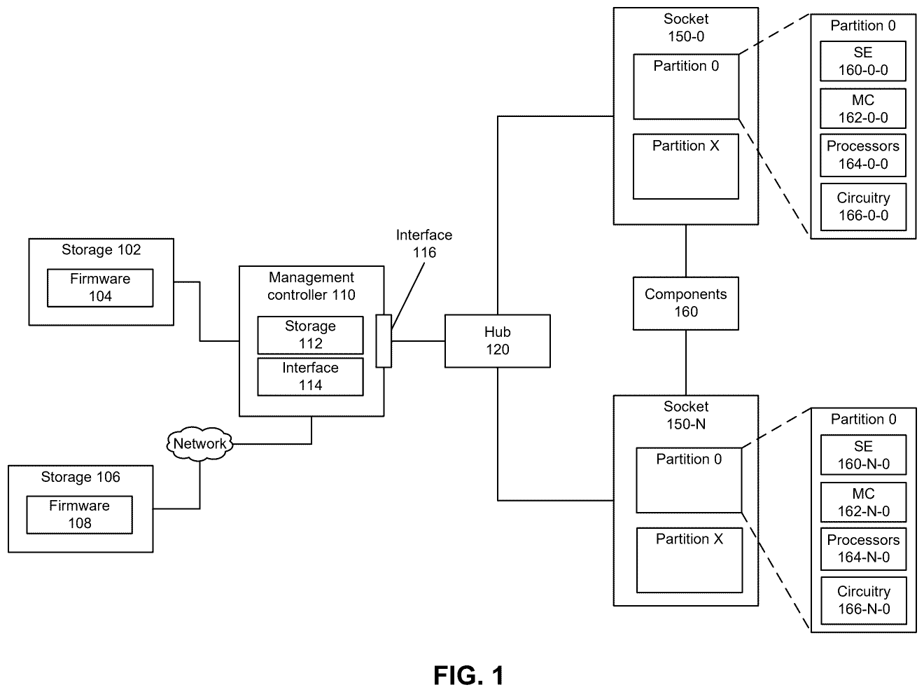

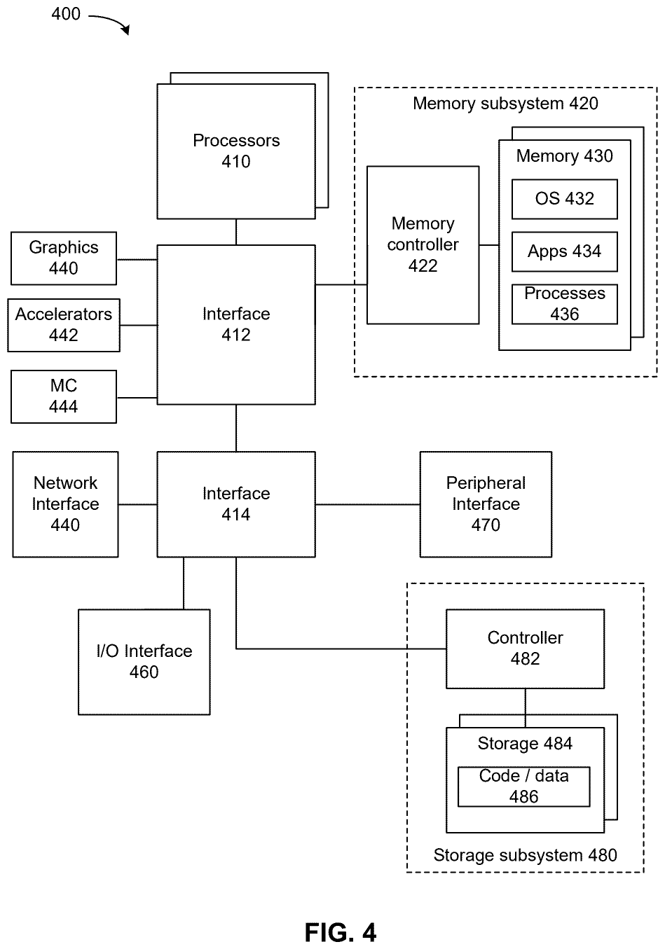

FIG. 1 depicts an example system that is to load firmware. In some examples, processor sockets 150-0 to 150-N can include associated processors, as well as silicon firmware and other software or circuitry described at least with respect to FIG. 4. In some examples, one or more of sockets 150-0 to 150-N can include metal contacts for pins or lands of processors and can be encased by a cover that is made of plastic. A processor socket can include a ball grid array (BGA), Pin Grid Array (PGA), Land Grid Array (LGA), or other interface that can couple a processor (e.g., processors 164-0-0 . . . 164-N-0 and 164-N-0 . . . 164-N-X) to a circuit board (e.g., printed circuit board (PCB)), without soldering the processor to the circuit board.

In some examples, sockets 150-0 to 150-N can include a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

One or more of processors of a processor socket can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processors can be heterogeneous or homogeneous processor types where processors in different sockets are a same type (e.g., CPU, GPU, NPU, etc.) or different type (e.g., a first socket includes a CPU and a GPU and a second socket includes a GPU and an NPU).

Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

One or more of sockets 150-0 to 150-N can utilize components 160. Components 160 can include programmable logic devices (PLD), voltage regulators (VRs), general purpose input output (GPIO) pins, partition multiplexers, switches, jumpers, or others.

One or more of sockets 150-0 to 150-N can operate in non-partitioned or partitioned mode. For example, in a non-partitioned mode, a platform can operate as a single node. For instance, one or more processor sockets in the non-partitioned mode can execute a single boot firmware and perform a handoff platform control to a single OS. Processors in the non-partitioned mode, including software (e.g., operating system (OS) or processes) can share resources such as connected memory, cores in different sockets, cache, connected input/output (I/O), device interface-connected devices (e.g., Peripheral Component Interconnect express (PCIe), Compute Express Link (CXL)) and other circuitry, firmware, or software. Processors in the non-partitioned mode can access memory in a coherent manner so that memory is shared among the processors.

For example, in a partitioned mode, a partitioned platform can operate as multiple separate sockets and can operate in independent power states (e.g., S0, S5, and so on), perform separate error handling, and not share one or more of: connected memory, cores in different sockets, cache, isolated input/output (I/O) communication interfaces, or device interface-connected devices. Partitions can operate as separate coherent domains. Moreover, in partitioned mode, different socket partitions can independently power cycle, utilize different and independent clock signals, different partitions can utilize isolated in-band and out-of-band channels, different partitions can independently communicate with one or more management controllers, different partitions can utilize one or more debug ports, different partitions can independently utilize one or more security engine devices that authenticate or validate different boot firmware, or others. Multiple processors can execute separate boot firmware code and handoff platform control to OSs executed by different processors. In a partitioned mode, peripheral or telemetry data may not be shared among different partitioned processor sockets, storage dependency may not be shared among different partitioned processor sockets, and so forth. In a partitioned mode, cross socket isolation can occur whereby sockets have independent power states. A catastrophic Reliability, Availability and Serviceability (RAS) event in a partition may not impact the run-time stability of another partitions.

For partitioned mode, bifurcation of resources (e.g., cache, memory, memory controllers, registers, processors, interfaces, physical layer interfaces, or others) among partitions may be equal or unequal and set based on service level agreement (SLA), service level objectives (SLO), application request, data center administrator configuration, or others.

For a socket or socket partition 0 to X of a socket, a respective security engine (SE) 160-0-0 to 160-0-X . . . 160-N-0 to 160-N-X can communicate with a corresponding management circuitry (MC) 162-0-0 to 162-0-X . . . 162-N-0 to 162-N-X. An SE can include a privileged firmware (FW) module executed in a processor of a processor socket. An SE can perform tasks such as secure boot to ensure that only trusted code runs at startup, key management, and attestation to prove the system's trustworthiness to other devices or software. In some examples, a security engine can include a Secure Startup Services Module (S3M).

For a socket or socket partition, a management circuitry (e.g., 162-0-0 to 162-0-X 162-N-0 to 162-N-X) can be utilized to communicate with management controller 110. For example, MC 162-0-0 can be utilized by partition 0 of socket 150-0 and MC 162-N-X can be utilized by partition X of socket 150-N. Management circuitry can include circuitry that provides communication consistent with Improved Inter Integrated Circuit (I3C), MIPI Alliance's I3C specification, Peripheral Component Interconnect express (PCIe), Compute Express Link (CXL), universal asynchronous receiver/transmitter (UART), or others. Management circuitry can be implemented as Intel® Out-of-Band Management Services Module (OOBMSM)), a multifunctional component that permits out-of-band management services for a processor socket partition, in a similar manner as management controller 110.

Storage 102 can store boot firmware image 104. Boot firmware image 104 can include boot firmware to boot security engines 160-0-0 to 160-0-X . . . 160-N-0 to 160-N-X and MCs 162-0-0 to 162-0-X 162-N-0 to 162-N-X for initializing the streaming boot channel to one or more processors and circuitries of a partition (e.g., 164-0-0 to 164-0-X . . . 164-N-0 to 164-N-X and 166-0-0 to 166-0-X . . . 166-N-0 to 166-N-X). Storage 102 or streamed boot firmware source 106 can store boot firmware 108. Boot firmware 108 can be streamed to processors and circuitries of one or more of sockets 150-0 to 150-N after execution of boot firmware 104. Boot firmware 108 can be executed by processors and circuitries of a partition at boot (e.g., one or more of processors 164-0-0 to 164-0-X . . . 164-N-0 to 164-N-X or circuitries 166-0-0 to 166-0-X . . . 166-N-0 to 166-N-X). Booting a processor can occur at device power-on, re-boot, restart, firmware update, or others. Booting a processor can cause execution of boot firmware and loading a bootloader to load an OS. In some examples, runtime configurations can update or upgrade formats of boot firmware images and data structures stored in storage 102 or 106.

In some examples, firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*. exe) files. This UEFI capsule can be deployed to a target platform as an SMM image via existing OS specific techniques (e.g., Windows Update for Azure, or LVFS for Linux).

Management controller 110 can perform management and monitoring capabilities for system administrators or orchestrators to manage and monitor operation at least of circuitry of one or more of sockets 150-0 to 150-N and devices connected thereto, such as, a network interface device and storage device, using channels, including in-band channels and out-of-band channels. Out-of-band channels can include packet flows or transmission media that communicate metadata and telemetry. In some examples, management controller 110 can be implemented as one or more of: Baseboard Management Controller (BMC), Intel® Management or Manageability Engine (ME), or other devices. In some examples, in addition, or alternatively, accelerator, network interface device, or other device can perform operations of management controller 110.

Management controller 110 can receive a segment of boot firmware image 104 from SPI flash 102 and forward boot firmware image 104, via hub 120, to one or more of: security engine (SE) 160-0-0 to 160-0-X . . . 160-N-0 to 160-N-X, or management circuitry (MC) 162-0-0 to 162-0-X . . . 162-N-0 to 162-N-X. Firmware 104 can include firmware for protocols and interfaces to stream firmware components for one or more of processors 164-0-0 to 164-0-X 164-N-0 to 164-N-X or circuitries 166-0-0 to 166-0-X . . . 166-N-0 to 166-N-X.

In some examples, firmware image 104 can be stored in storage 112 prior to boot of one or more of sockets 150-0 to 150-N. After execution of firmware 104 by one or more of SEs or MCs of sockets 150-0 to 150-N, management controller 110 can utilize interface 114 as a network interface device to stream content of segment of boot firmware 108 by an Ethernet or networking or local connection to one or more of sockets 150-0 to 150-N. Interface 114 (e.g., streaming boot interface) can be implemented as one or more of: a network interface device, a bus interface, a host interface, or others. Processors and circuitry of different processors sockets can execute different firmware, where the firmware is specific to the processors and circuitry. Although interface 114 is depicted as part of management controller 110, interface 114 can be part of a network interface device, accelerator, or other device.

Management controller 110 can communicate with an MC for one or more partitions. After an MC reads and executes boot image 104, management controller 110 can stream firmware 108 to one or more of sockets 150-0 to 150-N via interface 116 (e.g., streaming boot interface) and hub 120. Interface 116 and hub 120 can communicate with one or more of sockets 150-0 to 150-N in a manner consistent with one or more of: Ethernet, PCIe, CXL, I3C, SPI, Inter-Integrated Circuit (I2C), Universal Asynchronous Receiver/Transmitter (UART), Controller Area Network (CAN), SMBus, or others. Interface 116 and hub 120 can utilize protocols such as Management Component Transport Protocol (MCTP).

Firmware 108 for one or more of processors 164-0-0 to 164-0-X . . . 164-N-0 to 164-N-X or circuitries 166-0-0 to 166-0-X . . . 166-N-0 to 166-N-X can be streamed from storage 106 by interface 114. Firmware 108 for one or more of processors 164-0-0 to 164-0-X 164-N-0 to 164-N-X or circuitries 166-0-0 to 166-0-X . . . 166-N-0 to 166-N-X can be utilized by one or more of: processor, memory controller for memory training and Reliability, Availability and Serviceability (RAS), memory input output (IO), physical layer interface (PHY), Input/Output Memory Management Unit (IOMMU), IO subsystem, accelerator, uncore, debug, or others.

Hub 120 can access interface 116 of management controller 120 by a number A of interface pins instead of B number of pins from sockets 150-0 to 150-N to reduce a pin count in a circuit board, where A is less than B. Hub 120 can forward and broadcast communications between sockets and interface 116.

In some examples, management controller 110, hub 120, and/or processor sockets 150-0 to 150-N can be positioned on one or more circuit boards or connected modules.

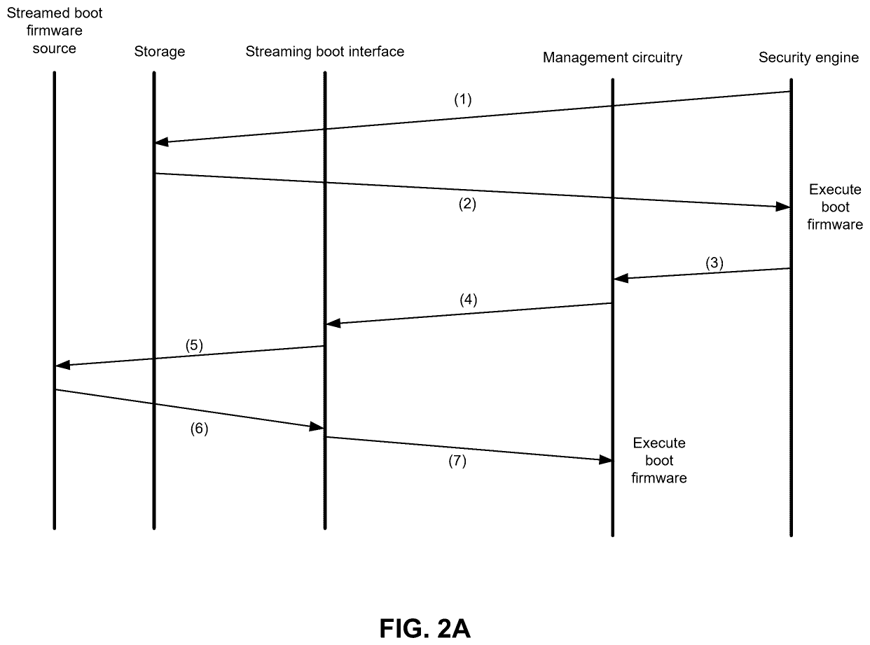

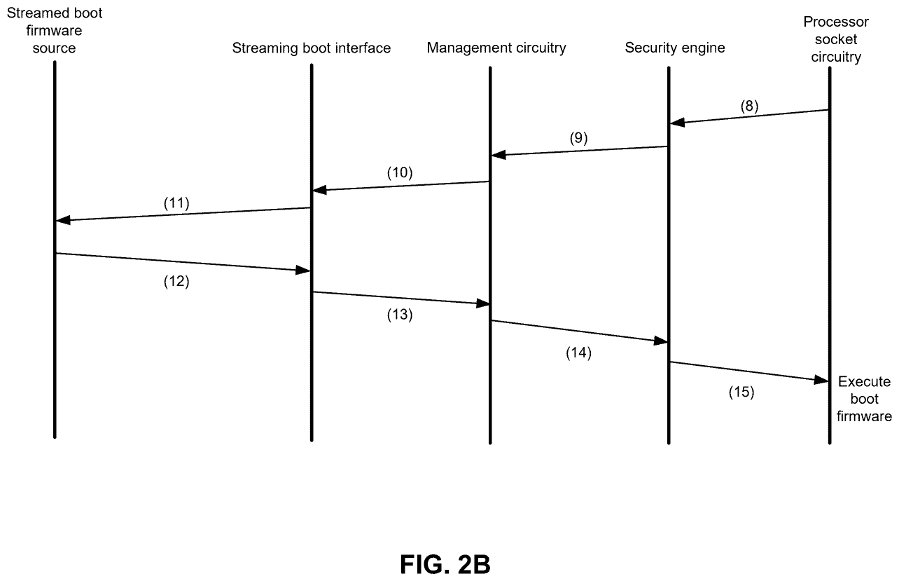

FIGS. 2A and 2B depict an example process to load boot firmware. Referring to FIG. 2A, at (1), an SE can request boot firmware from boot firmware storage. For example, an SE can request boot firmware from a SPI flash over a SPI interface. At (2), boot firmware storage can provide the boot firmware to the requesting SE for execution. At (3), based on successful execution of boot firmware by the SE, the SE can request management circuitry to request boot firmware for the management circuitry. At (4), the management circuitry can request streaming boot interface for boot firmware for the management circuitry. At (5), streaming boot interface can request streamed boot firmware for the management circuitry from a streamed boot firmware source. At (6), streamed boot firmware source can provide boot firmware for management circuitry to streaming boot interface. At (7), streaming boot interface can provide boot firmware for management circuitry to management circuitry. Based on successful execution of boot firmware by management circuitry and SE, streaming of boot firmware for processor socket circuitry can commence.

Referring to FIG. 2B, at (8), processor socket circuitry can request SE for boot firmware for the processor socket circuitry. Processor socket circuitry can include a processor, device interface, input/output (I/O) circuitry, or other circuitry described herein (e.g., processors 164-0-0 to 164-0-X . . . 164-N-0 to 164-N-X or circuitries 166-0-0 to 166-0-X . . . 166-N-0 to 166-N-X). At (9), SE can request management circuitry for the boot firmware. At (10), management circuitry can request a streaming boot interface for the boot firmware. At (11), the streaming boot interface can access the boot firmware from a streamed boot firmware source. The streamed boot firmware source can be the same or different than the storage device that stores the firmware for the SE and management circuitry. Multiple MC and SE of different partitions or processor sockets can load firmware in parallel. Multiple processor sockets can load firmware in parallel.

At (12), the streamed boot firmware source can provide the boot firmware to the streaming boot interface. At (13), the streaming boot interface can provide the boot firmware to management circuitry. At (14), the management circuitry can provide the boot firmware to the SE. At (15), the SE can provide the boot firmware to the processor socket circuitry for execution.

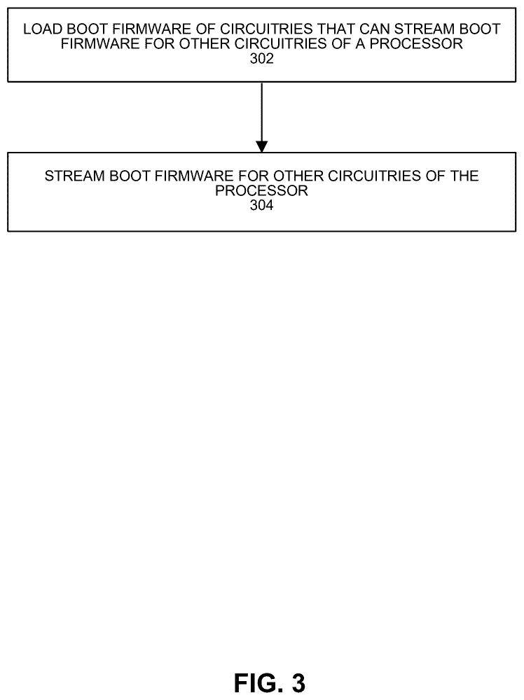

FIG. 3 depicts an example process at boot or reboot of a processor. At 302, a communication circuitry for a processor, that is to receive boot firmware, can access boot firmware from a boot firmware storage device. At 304, after the communication circuitry loading and executing boot firmware, the processor can utilize the communication circuitry to load boot firmware by streaming boot firmware from the same or different boot firmware storage device. Streaming boot firmware can include accessing the boot firmware from a network accessible storage device or a storage device connected via a device interface or bus.

FIG. 4 depicts a system. The system can use examples to stream boot firmware to various circuitries of system 400 (e.g., processor 410, graphics 440, one or more of accelerators 442, management controller (MC) 444, and/or network interface 450), as described herein. System 400 includes processor 410, which provides processing, operation management, and execution of instructions for system 400. Processor 410 can include any type of microprocessor, central processing unit (CPU), graphics processing unit (GPU), processing core, or other processing hardware to provide processing for system 400, or a combination of processors. Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 400 includes interface 412 coupled to processor 410, which can represent a higher speed interface or a high throughput interface for system components that needs higher bandwidth connections, such as memory subsystem 420 or graphics interface components 440, accelerators 442, or management controller 444. Interface 412 represents an interface circuit, which can be a standalone component or integrated onto a processor die.

Accelerators 442 can be a fixed function or programmable offload engine that can be accessed or used by a processor 410. For example, an accelerator among accelerators 442 can provide data compression (DC) capability, cryptography services such as public key encryption (PKE), cipher, hash/authentication capabilities, decryption, or other capabilities or services. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 442 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as static random-access memory (SRAM), dynamic random-access memory (DRAM), or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. In some examples, network interface 450 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory.

Some examples of network interface 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 450 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDAR, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory is memory whose state (and therefore the data stored in it) is indeterminate if power is interrupted to the device. A non-volatile memory (NVM) device is a memory whose state is determinate even if power is interrupted to the device.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., Peripheral Component Interconnect express (PCIe), Compute Express Link (CXL), UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples and an apparatus that includes: a first processor comprising first circuitry and second circuitry, wherein: the first circuitry is to load first boot firmware for execution by the first circuitry, based on execution of the first boot firmware by the first circuitry, the first circuitry is to provide the second circuitry with access to streamed second boot firmware, and the second circuitry is to request the first circuitry to stream second boot firmware for execution by the second circuitry.

Example 2 includes one or more examples, wherein: the load first boot firmware for execution by the first circuitry comprises load the boot firmware from a first memory device via a serial peripheral interface (SPI) and the stream second boot firmware comprises load the second firmware from a second memory device accessible via Ethernet packets.

Example 3 includes one or more examples and a second processor comprising third circuitry and fourth circuitry, wherein: the third circuitry is to load third boot firmware for execution by the third circuitry, based on execution of the third boot firmware by the third circuitry, the third circuitry is to load fourth boot firmware for execution by the fourth circuitry, and the fourth circuitry is to request the third circuitry to stream fourth boot firmware for execution by the fourth circuitry.

Example 4 includes one or more examples, wherein: the first circuitry is to load the first and the second boot firmware by communication with a management controller and the third circuitry is to load the third and the fourth boot firmware by communication with the management controller.

Example 5 includes one or more examples, wherein: the first circuitry comprises a security engine for a partition of the first processor.

Example 6 includes one or more examples, wherein: the first circuitry is to provide out-of-band management services for a partition of the first processor.

Example 7 includes one or more examples, wherein the second circuitry comprises one or more of: a processor, memory controller, memory input output (IO), physical layer interface (PHY), Input/Output Memory Management Unit (IOMMU), or an accelerator.

Example 8 includes one or more examples and a method that includes: booting a processor by: reading, by a communication circuitry of the processor, boot firmware from a boot firmware storage device; executing, by the communication circuitry, the boot firmware; after the communication circuitry loads and executes the boot firmware, circuitry of the processor utilizing the communication circuitry to load boot firmware by streaming boot firmware from a second boot firmware storage device; and executing, by the circuitry of the processor, the streamed boot firmware.

Example 9 includes one or more examples, wherein the reading, by the communication circuitry of the processor, boot firmware from the boot firmware storage device comprises loading the boot firmware from a flash memory device via a serial peripheral interface (SPI).

Example 10includes one or more examples, wherein the communication circuitry comprises a processor security engine and processor management circuitry.

Example 11 includes one or more examples, wherein the streaming boot firmware from the second boot firmware storage device comprises loading the boot firmware by receiving Ethernet packets

Example 12 includes one or more examples, wherein the circuitry of the processor comprises one or more of: a processor, memory controller, memory input output (IO), physical layer interface (PHY), Input/Output Memory Management Unit (IOMMU), or an accelerator.

Example 13 includes one or more examples, wherein the processor comprises a non-partitioned processor.

Example 14 includes one or more examples, wherein the processor comprises a partition of a processor and the communication circuitry and circuitry are associated with the partition.

Example 15 includes one or more examples and at least one non-transitory computer-readable medium comprising instructions stored thereon, that when executed by one or more circuitry, cause the one or more circuitry to: boot a processor by: read, by a communication circuitry of the processor, boot firmware from a boot firmware storage device and based on the communication circuitry loading and executing the boot firmware, circuitry of the processor utilizing the communication circuitry to load boot firmware by streaming boot firmware from a second boot firmware storage device.

Example 16 includes one or more examples, wherein the reading, by the communication circuitry of the processor, boot firmware from the boot firmware storage device comprises loading the boot firmware from a flash memory device via a serial peripheral interface (SPI).

Example 17 includes one or more examples, wherein the streaming boot firmware from the second boot firmware storage device comprises loading the boot firmware by receiving Ethernet packets.

Example 18 includes one or more examples, wherein the communication circuitry comprises a processor security engine and processor out of band management circuitry.

Example 19 includes one or more examples, wherein the circuitry of the processor comprises one or more of: a processor, memory controller, memory input output (IO), physical layer interface (PHY), Input/Output Memory Management Unit (IOMMU), or an accelerator.

Example 20 includes one or more examples, wherein the processor comprises a partition of a processor socket.

1. An apparatus comprising:
a first processor comprising:
first circuitry and second circuitry, wherein:
the first circuitry is to load first boot firmware for execution by the first circuitry,
based on execution of the first boot firmware by the first circuitry, the first circuitry is to provide the second circuitry with access to streamed second boot firmware, and
the second circuitry is to request the first circuitry to stream second boot firmware for execution by the second circuitry.

2. The apparatus of claim 1, wherein:
the load first boot firmware for execution by the first circuitry comprises load the boot firmware from a first memory device via a serial peripheral interface (SPI) and
the stream second boot firmware comprises load the second firmware from a second memory device accessible via Ethernet packets.

3. The apparatus of claim 1, comprising:
a second processor comprising:
third circuitry and fourth circuitry, wherein:
the third circuitry is to load third boot firmware for execution by the third circuitry,
based on execution of the third boot firmware by the third circuitry, the third circuitry is to load fourth boot firmware for execution by the fourth circuitry, and
the fourth circuitry is to request the third circuitry to stream fourth boot firmware for execution by the fourth circuitry.

4. The apparatus of claim 3, wherein:
the first circuitry is to load the first and the second boot firmware by communication with a management controller and
the third circuitry is to load the third and the fourth boot firmware by communication with the management controller.

5. The apparatus of claim 1, wherein:
the first circuitry comprises a security engine for a partition of the first processor.

6. The apparatus of claim 1, wherein:
the first circuitry is to provide out-of-band management services for a partition of the first processor.

7. The apparatus of claim 1, wherein the second circuitry comprises one or more of: a processor, memory controller, memory input output (IO), physical layer interface (PHY), Input/Output Memory Management Unit (IOMMU), or an accelerator.

8. A method comprising:
booting a processor by:
reading, by a communication circuitry of the processor, boot firmware from a boot firmware storage device;
executing, by the communication circuitry, the boot firmware;
after the communication circuitry loads and executes the boot firmware, circuitry of the processor utilizing the communication circuitry to load boot firmware by streaming boot firmware from a second boot firmware storage device; and
executing, by the circuitry of the processor, the streamed boot firmware.

9. The method of claim 8, wherein the reading, by the communication circuitry of the processor, boot firmware from the boot firmware storage device comprises loading the boot firmware from a flash memory device via a serial peripheral interface (SPI).

10. The method of claim 8, wherein the communication circuitry comprises a processor security engine and processor management circuitry.

11. The method of claim 8, wherein the streaming boot firmware from the second boot firmware storage device comprises loading the boot firmware by receiving Ethernet packets.

12. The method of claim 8, wherein the circuitry of the processor comprises one or more of: a processor, memory controller, memory input output (IO), physical layer interface (PHY), Input/Output Memory Management Unit (IOMMU), or an accelerator.

13. The method of claim 8, wherein the processor comprises a non-partitioned processor.

14. The method of claim 8, wherein the processor comprises a partition of a processor and the communication circuitry and circuitry are associated with the partition.

15. At least one non-transitory computer-readable medium comprising instructions stored thereon, that when executed by one or more circuitry, cause the one or more circuitry to:
boot a processor by:
read, by a communication circuitry of the processor, boot firmware from a boot firmware storage device and
based on the communication circuitry loading and executing the boot firmware, circuitry of the processor utilizing the communication circuitry to load boot firmware by streaming boot firmware from a second boot firmware storage device.

16. The computer-readable medium of claim 15, wherein the reading, by the communication circuitry of the processor, boot firmware from the boot firmware storage device comprises loading the boot firmware from a flash memory device via a serial peripheral interface (SPI).

17. The computer-readable medium of claim 15, wherein the streaming boot firmware from the second boot firmware storage device comprises loading the boot firmware by receiving Ethernet packets.

18. The computer-readable medium of claim 15, wherein the communication circuitry comprises a processor security engine and processor out of band management circuitry.

19. The computer-readable medium of claim 15, wherein the circuitry of the processor comprises one or more of: a processor, memory controller, memory input output (IO), physical layer interface (PHY), Input/Output Memory Management Unit (IOMMU), or an accelerator.

20. The computer-readable medium of claim 15, wherein the processor comprises a partition of a processor socket.
